(19) United States
(12) Patent Application Publication
(10) Pub. No.: US 2012/0124472 A1
(43) Pub. Date: May 17, 2012

(54) SYSTEM AND METHOD FOR PROVIDING INTERACTIVE FEEDBACK FOR MOUSE GESTURES

(75) Inventors: Christopher David Pine, Oslo (NO); Christopher Svendsen, Olso (NO)

(73) Assignee: OPERA SOFTWARE ASA, Olso (NO)

(21) Appl. No.: 13/297,019

(22) Filed: Nov. 15, 2011

Related U.S. Application Data
(60) Provisional application No. 61/413,525, filed on Nov. 15, 2010.

(51) Int. Cl. G06F 3/048

(52) U.S. Cl. 715/707

(57) ABSTRACT

The invention is directed to a method, computer system, and computer program for providing a user feedback regarding available mouse gestures. Each of the mouse gestures comprises a predetermined sequence of one or more mouse movements, and corresponds to a predetermined action or command. After the gesture is initiated, the feedback is provided to the user when a predetermined timer expires since the user initiated the gesture or the last mouse movement. This allows for feedback to be provided to users who get lost mid-gesture, without providing unnecessary feedback to a more experienced user who is able to quickly perform the gesture. The feedback can instruct the user as to each available gesture, along with the corresponding action or command.

### CROSS-REFERENCE TO RELATED APPLICATION

The present application claims priority under 35 U.S.C. §119(e) to U.S. provisional patent application No. 61/413,525 filed Nov. 15, 2010, the entire contents of which are herein incorporated by references in their entirety.

### FIELD OF THE INVENTION

The present invention is directed to providing a user with feedback while performing a mouse gesture.

### BACKGROUND

For computer applications utilizing a graphical user interface, a popular type of input device is referred to as a “mouse.” A conventional mouse device is held under one of the user's hands, and moved in two-dimensions across a supporting surface (e.g., mouse pad) in order to control the location of a pointer on the computer screen. Further, a mouse generally contains buttons (typically including a left and right button) which are pressed down by the user to perform various functions. A computer mouse may also contain other types of switches and controls, e.g., a scroll wheel.

There are various types of mouse devices. An example is a mechanical mouse which detects the two-dimensional motion across its underlying surface by tracking the rotation of a trackball rolling against the surface. Another example is an optical mouse that uses a light source and photodiodes to detect its movement relative to the surface. There are also other types of pointer devices that do not require an underlying surface to operate. E.g., an “air mouse” allows a user to manipulate a trackball with his thumb, and tracks the rotation of the trackball along the two axes, to control the location of the pointer. Other types of pointer devices, e.g., touch pads, translates the movement of a user's finger or stylus into a relative position for the pointer on the screen. For purposes of this invention, each of the aforementioned types of pointer devices is considered a “mouse.”

Existing computer applications have allowed the use of “mouse gestures” as shortcuts to execute certain commands or actions. However, there may be numerous mouse gestures available, and some of the gestures may require a combination of mouse movements. This makes it difficult for a beginning user of the application to learn what gestures are available. Also, for a mouse gesture comprising multiple movements, it is possible for a user to lose track of where he is mid-gesture. Furthermore, even if such user completes a gesture, it can be difficult for him to know what gesture he just completed.

In view of the difficulty in learning mouse gestures, as well as knowing what happened when a mistake is made, it would be advantageous for a user to receive feedback to help them perform such gestures.

### SUMMARY OF THE INVENTION

The present invention relates to a method, system, and computer program for providing a user feedback as to available mouse gestures when needed. When provided, the feedback may indicate which directions (or mouse movements) correspond to which action or command.

According to an exemplary embodiment, a predetermined timer may be set when the user initiates gesture (e.g., by pressing down the right mouse button), and reset after each mouse movement during the gesture. The feedback may then be provided whenever such timer expires before completion (or termination) of the gesture. Thus, an experienced user who is able to quickly perform the associated movement(s) for the intended mouse gesture need not be bothered with unnecessary feedback.

According to another exemplary embodiment, when provided, the feedback may be displayed as an overlay interface on the display screen. For instance, the display location of the interface may be determined based on the current location of the pointer. This would allow the overlay interface to be located nearby the pointer.

According to another exemplary embodiment, when feedback is provided to the user during a mouse gesture, the completion of such gesture may result in a confirmation being provided. Such confirmation may notify the user of the action or command that was carried out as a result of the completed gesture, as well as the combination of mouse movement(s) associated with the gesture.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein

FIG. 1 is a block diagram illustrating a computing environment that can be used for implementing exemplary embodiments of the present invention;

FIG. 2 is illustrating a process for processing mouse gestures and providing a user feedback with regard to the mouse gestures, according to an exemplary embodiment of the present invention;

FIG. 3 is a flowchart illustrating another, more-specific exemplary embodiment of a process for processing mouse gestures and providing a user feedback with regard to the mouse gestures, in accordance with the present invention;

FIGS. 4A, 4B, and 4C illustrate the partitioning of a display area into regions relative to the pointer location for purposes of providing feedback, according to an exemplary embodiment of the present invention;

FIGS. 5-7 are screen shots illustrating a particular scenario consistent with the exemplary embodiments of the present invention; and

FIG. 8 illustrates examples of mouse gestures that can be implemented in an application such as a web browser, according to an exemplary embodiment of the present invention.

The drawings will be described in detail in the course of the detailed description of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The present invention is directed to providing a user feedback regarding available mouse gestures, when needed, according to one or more of the exemplary embodiments described in detail below.

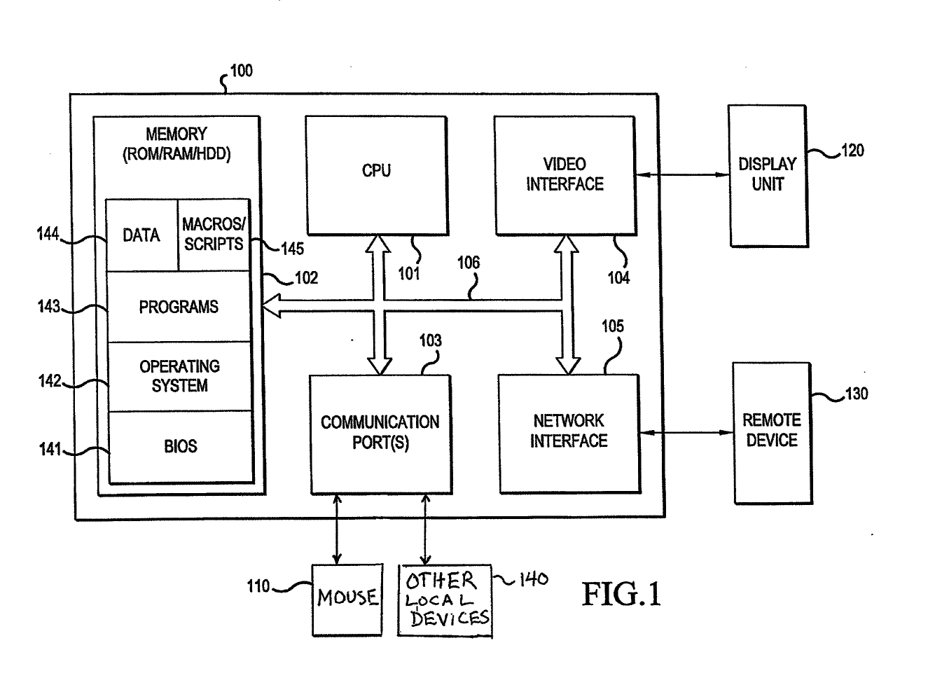

FIG. 1 illustrates a generalized computer system 100 that can be used as an environment for implementing various aspects of the present invention. According to exemplary embodiments, it is contemplated that the computer system 100 may be implemented as any of various types of general purpose computers, including but not limited to servers, desktop computers, laptop computers, distributive computing systems, and any other type of computing devices and systems as will be contemplated by those of ordinary skill in the art.

In FIG. 1, computer system 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memory, stores the various software components of the system. The software components in the memory 102 may include a basic input/output system (BIOS) 141, an operating system 142, various computer programs 143 including applications and device drivers, various types of data 144, and other executable files or instructions such as macros and scripts 145.

It is contemplated that principles of the invention described hereinbelow can be implemented as a result of the CPU 101 executing one or a combination of the computer programs 143. For instance, if the mouse gestures are to be used as a means for performing certain actions or commands in an application program 143, such program 143 might have code written therein for recognizing the mouse gestures and invoking the corresponding action/command in the application. Alternatively, the code that is executed by the CPU 101 to implement the mouse gestures may be external to the relevant application in such manner that will be readily apparent to persons of ordinary skill in the art.

A communication port 103 may be connected to a mouse device 110. Other communication ports may be provided and connected to other local devices 140, such as additional user input devices, a printer, a media player, external memory devices, and special purpose devices such as e.g. a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for the mouse 110 and any other local devices 140.

While the mouse device 110 may be configured as an external input device with regard to the computer system 100, as shown in FIG. 1, the mouse device 110 may alternatively be configured as part of the computer system 100. For instance, the mouse 110 may be configured as a touch pad, or other type of pointer device, that is integrated with the housing of the computer system 100 (e.g., for a laptop computer). Also, principles of this invention may be applied using an integrated touch screen interface as the mouse 110. Furthermore, it is possible for multiple mouse devices 110 to be used consistent with the principles of the present invention. For instance, both an external mouse 110 (e.g., optical mouse) and an integrated mouse 110 (e.g., touch pad or touch screen interface) may be used with the computer system 100 to implement principles of the present invention.

The video interface device 104 is connected to a display unit 120. The display unit 120 might be an integrated display. For instance, if the computer system 100 is implemented in a portable device, such as a laptop or “netbook” computer, the display will generally be an integrated display such as an LCD display. However, the display unit 120 does not have to be integrated with the other elements of the computer system 100, and can instead be implemented as a separate device, e.g., a standalone monitor.

The network interface device 105 provides the computer system 100 with the ability to connect to a network in order to communicate with a remote device 130. The communication network, which in FIG. 1 is only illustrated as the line connecting the network interface 105 with the remote device 130, may be, e.g., a local area network or the Internet. The remote device 130 may in principle be any computing device or system with similar communications capabilities as the system 100, such as a server or some other unit providing a networked service.

It will be understood that the computer system 100 illustrated in FIG. 1 is not limited to any particular configuration or embodiment regarding its size, resources, or physical implementation of components. For example, more than one of the functional components illustrated in FIG. 1 may be combined into a single integrated unit of the system 100. Also, a single functional component of FIG. 1 may be distributed over several physical units. Other units or capabilities may of course also be present. Furthermore, while it is contemplated that the system 100 may be implemented using general purpose computers or servers, various aspects of the present invention could be implemented using a system 100 that is smaller and/or has more limited processing capabilities (e.g. a laptop or netbook computer, a personal digital assistant (PDA) or a set-top box system or other home-entertainment unit).

Mouse gestures may be implemented within a computer system 100 as illustrated in FIG. 1 according to principles described hereinafter.

According to an exemplary embodiment, each mouse gesture is associated with a predefined sequence of one or more mouse movements. Each of these mouse movements may comprise a simple movement of the mouse in a particular direction. An example of a sequence of mouse movements for a given mouse gesture might be LEFT-DOWN. In order to implement such a gesture, the user might need to press down on the right mouse button, sequentially move the mouse 110 left and then down, and then release the right mouse button. Upon release of the button, the corresponding action or command would then be executed.

According to a further exemplary embodiment, it may be necessary for the mouse 110 to move a predetermined distance to be recognized. Consider again the above example of the mouse gesture whose sequence of mouse movements is LEFT-DOWN. In this case, the user might be required to move the mouse at least ten (10) pixels to the left and then at least ten (10) pixels down while the right mouse button is pressed down.

In the above examples, the initial pressing-down of the right mouse button by the user can be considered an “initiating event” for the gesture. According to an exemplary embodiment, such an initiating event can be required of the user in order to initiate each gesture. However, it is not required that the initiating event be the initial pressing-down of the right mouse button. Other possible initiating events for a mouse gesture according to the principles of the invention may include the initial pressing-down of the left (or another) mouse button, or other types of user actions such as the depression of a keyboard key.

Also, after the user performed an initiating event for a mouse gesture, the gesture may terminate upon occurrence of a “terminating event.” One such terminating event may be the successful recognition of the mouse gesture, resulting in the execution of the corresponding action or command. However, another terminating event may be a mouse movement that does not correspond to a valid mouse gesture.

For instance, consider an example where the user intends to perform a single-movement mouse gesture by holding the right mouse button down while moving the mouse to the left, and then releasing the button (the sequence for such gesture would be simply LEFT). Here, upon release of the button, the successful recognition of the mouse gesture is considered a terminating event, resulting in execution of the corresponding command or action. Now, consider the situation where the user intends to perform the same mouse gesture, but after moving the mouse to the left, mistakenly moves the mouse downward before releasing the right mouse button. In this case, if the sequence LEFT-DOWN is not associated with any other valid mouse gesture, the last mouse movement downward may be recognized as a terminating event (even if the user has not yet released the mouse button).

It is further contemplated that an additional terminating event may optionally be provided in the form of a “timeout.” For instance, this may be desirable if the user is not required to hold down the right mouse button during the mouse gesture, and thus could forget that he is in the middle of a gesture. This optional timeout could arise, e.g., after a minute of inactivity.

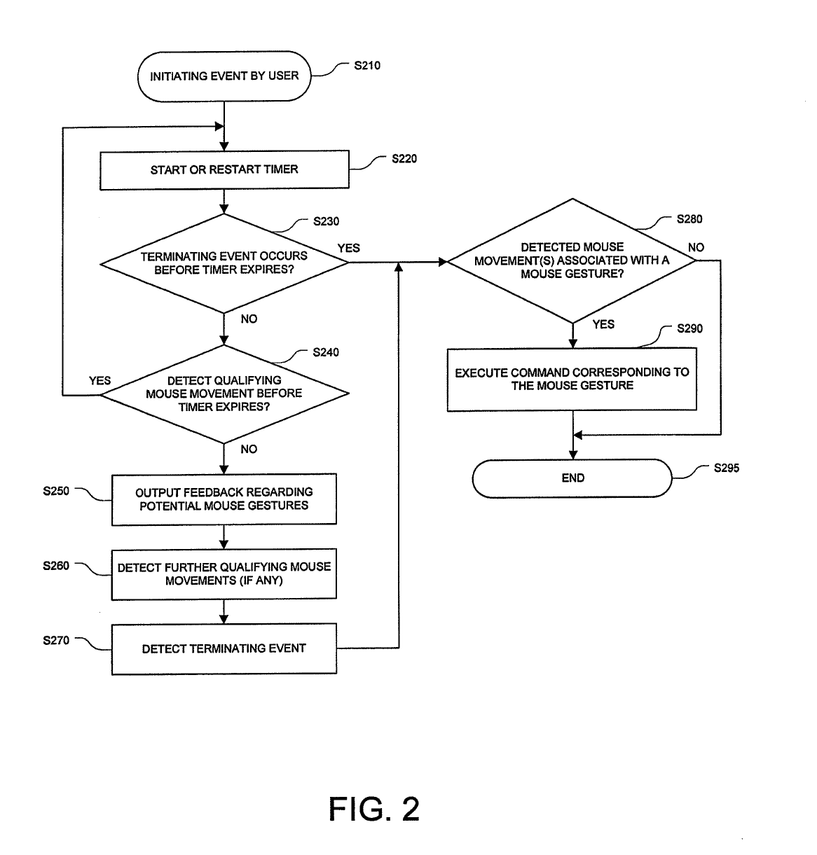

FIG. 2 is illustrating a process for processing mouse gestures and providing a user feedback with regard to the mouse gestures, according to an exemplary embodiment of the present invention. This process is initiated in S210 when an initiating event for a mouse gesture is detected. As discussed above, the initiating event may be the initial pressing-down of the right mouse button. As a result of detection of the initiating event in S210, a predetermined timer is started according to S220. According to an exemplary embodiment, this timer may be set for a half-second (i.e., 500 milliseconds). However, other timer durations are possible.

As shown in FIG. 2, a determination is made as to whether either of the following has occurred before expiration of the timer: the mouse gesture has been terminated (see S230), or the user has started moving the mouse in accordance with the intended gesture (see S240). If neither has occurred before expiration of the timer, then feedback is outputted to the user regarding potential mouse gestures that are available to him, as shown in S250.

According to an exemplary embodiment, the feedback of S250 may be displayed in an overlay interface on the screen. However, the feedback could also, or alternatively, be outputted in other ways. For instance, the feedback could be provided in audible form, e.g., through speakers connected to the computer system 100. The types of information that can be provided to the user as feedback will be explained in further detail below in connection with FIGS. 5-7.

Some reasons for waiting for the aforementioned timer to expire before providing feedback are as follows. People who regularly use mouse gestures might feel that the feedback is annoying and, if displayed, gets in their way. Also, it is possible that the initiating event might involve an action that could also be used for an unrelated function. For instance, consider the above examples where the right mouse button is held down while performing the mouse gesture. Generally, the right mouse button also has the function, at least for right-handed users, of bringing up what is called a “context menu.” As such, if a user clicks the right mouse button intending to bring up the context menu, rather than initiate a mouse gesture, the user would not want to receive any feedback with regard to gestures. To suit this situation, it would be advantageous not to immediately output the feedback, but instead wait some period of time (e.g., a half-second) after the initiating event.

Furthermore, in order to enable experienced users to perform longer mouse gestures without having to rush to complete the entire gesture to avoid receiving the feedback, the timer can be reset after each mouse movement that is part of the gesture's sequence. Thus, as shown in FIG. 2, if a “qualifying” mouse movement (i.e., one that corresponds to a valid mouse gesture) is detected before the timer expire in S240, then the timer is restarted in S220.

If the feedback is outputted according to S250, a terminating event is (eventually) detected as set forth in S270. According to an exemplary embodiment, the feedback may continue to be displayed until the terminating event is detected. Furthermore, in between S250 and S270, it is also possible that further qualifying mouse movements will be detected as shown in S260. Accordingly, in a further embodiment, the feedback may be updated if further qualifying mouse movements are detected before the terminating event.

When the terminating event occurs, either as a “YES” decision to S230 or S270, subsequent processing will depend on whether or not the detected terminating event was the successful completion of a valid mouse gesture. In other words, subsequent processing depends on whether the detected mouse movements between the initiating and terminating events correspond to a predetermined sequence of one or more mouse movements that is associated with a mouse gesture, as shown in S280. If the terminating event was a successful completion of a mouse gesture (i.e., “YES” decision in S280), then the predefined command or action corresponding to such mouse gesture is executed in S290.

For example, the terminating event might be the release of the right mouse button upon successful completion of the sequence of mouse movements for a valid gesture (assuming that the initial pressing-down of such button was the initiating event). In this event, S290 would invoke the corresponding action or command.

However, as described above, another type of terminating event is detection of a mouse movement that, in the current state, does not fit in the sequence associated with any valid mouse gesture. In this case, no mouse gesture was successfully completed (i.e., “NO” decision in S280) and no command/action is executed before the process of FIG. 2 is finished in S295.

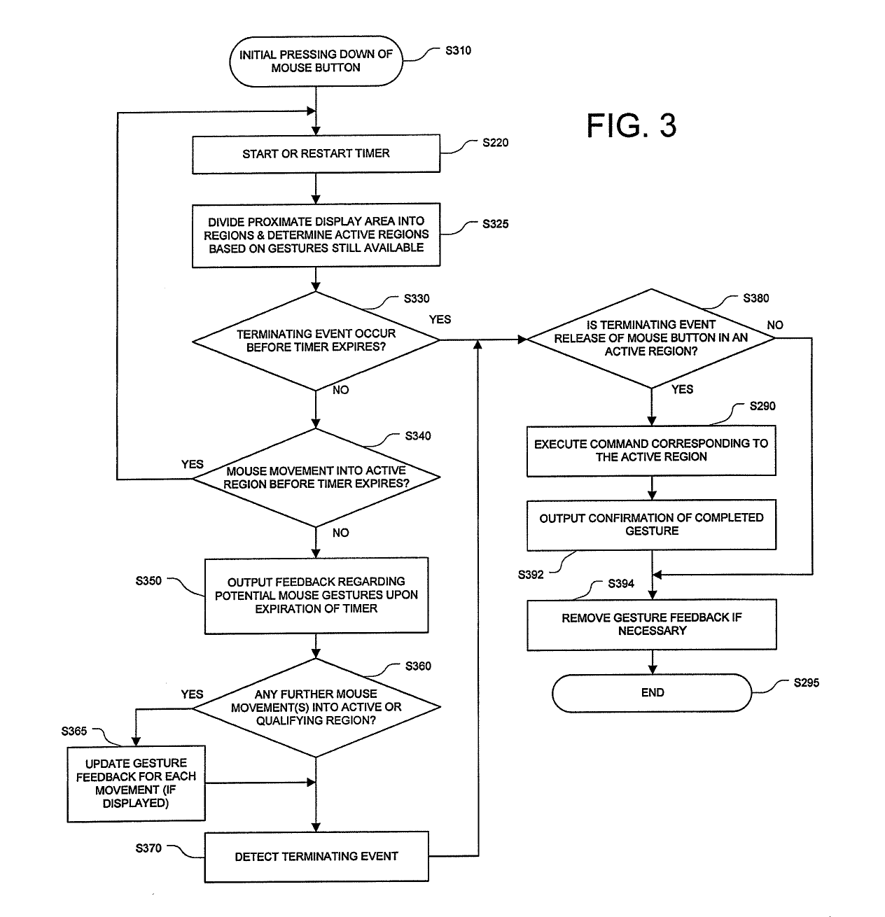

FIG. 2 illustrates a rather general exemplary embodiment of the present invention with regard to recognizing mouse gestures, and providing user feedback with regard to the mouse gestures when necessary. a more specific exemplary embodiment is illustrated in FIG. 3, and will be described in detail below.

It should be noted that FIGS. 2 and 3 are provided for purposes of illustrating exemplary embodiments of the invention, and is not intended to be limiting on the invention. For instance, it will be noted that changes may be made to the order of operations as illustrated in FIGS. 2 and 3, and that certain operations illustrated therein are optional and may be omitted without departing from the spirit and scope of the invention.

As alluded to earlier, FIG. 3 is a flowchart illustrating with greater specificity a process for processing mouse gestures and providing a user feedback with regard to the mouse gestures, according to an exemplary embodiment of the present invention. In FIG. 3, various elements or operations share the same reference numbers as similar elements/operations of FIG. 2. Thus, a detailed description of such elements, as already provided in connection with FIG. 2, need not be repeated below in connection with FIG. 3.

According to the particular exemplary embodiment of FIG. 3, the mouse gesture is initiated in S310 by the user initially pressing down a mouse button, e.g., the context menu button (which may or may not be the right mouse button), such button being pressed down for the duration of the gesture. In response to this initiating event, a predetermined timer is started in S220.

Further, the operations of S325 are also performed in response to the initiating event. According to S325, the screen or display area is divided into a set of regions relative to the current pointer location, and a determination is made as to which of these regions are “active,” i.e., correspond to a valid mouse gesture. As will be explained in further detail below, these operations help facilitate a determination of whether each mouse movement by the user is part of a valid mouse gesture.

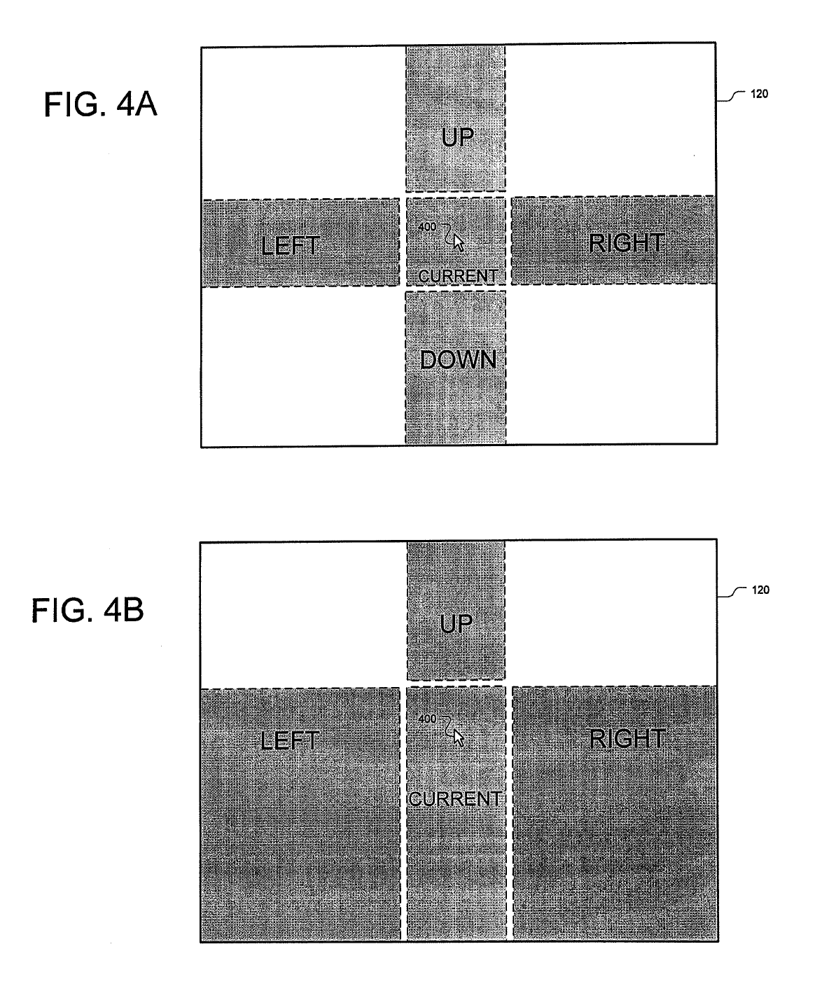

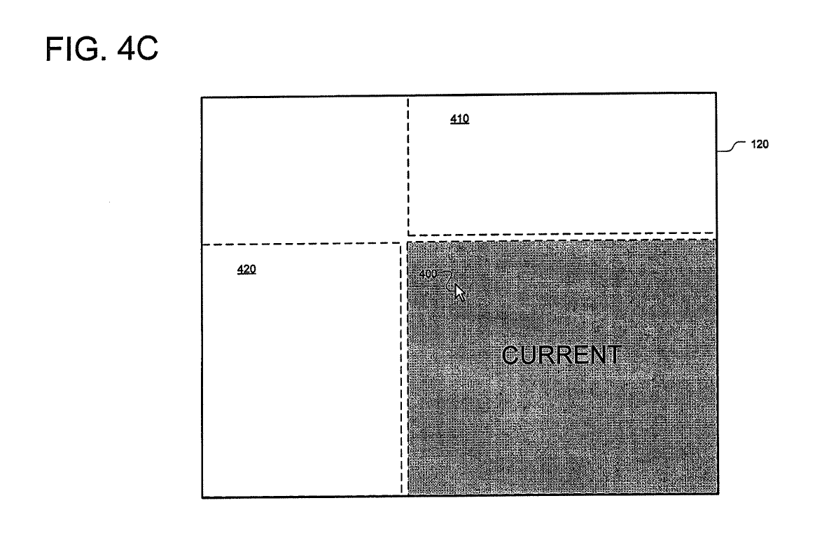

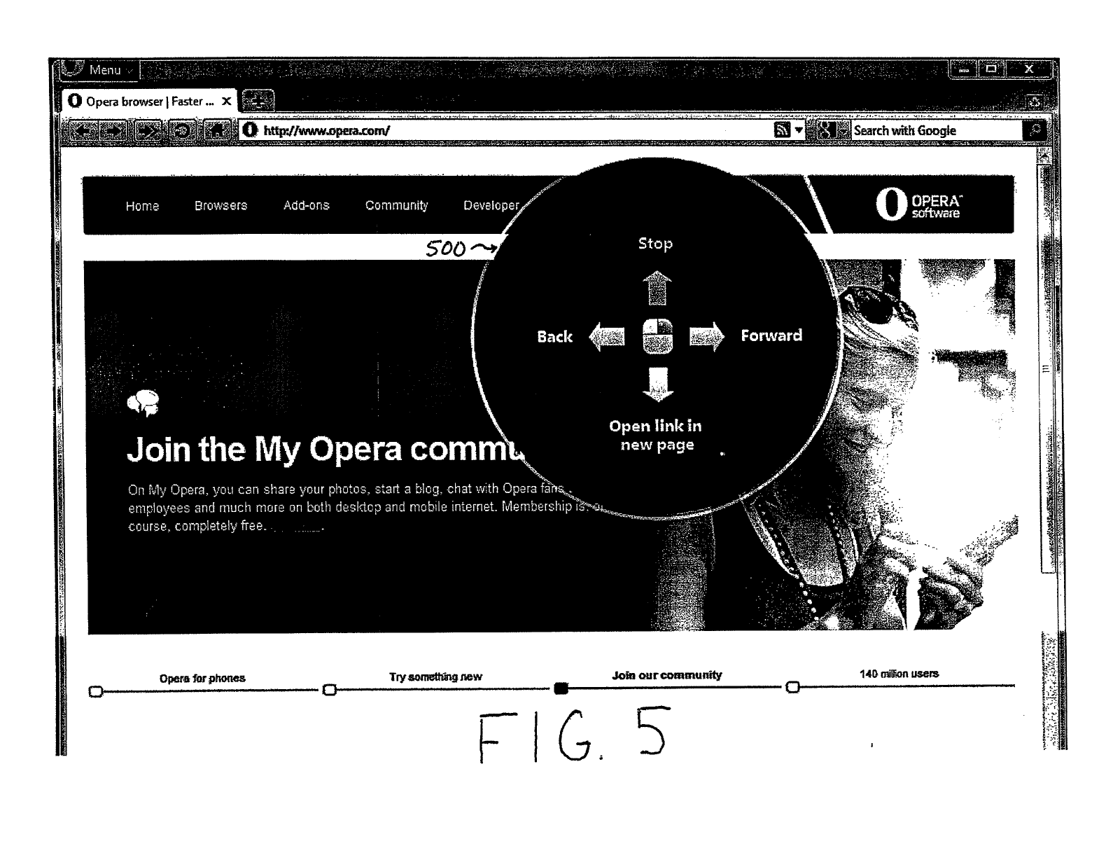

To help explain the concept of regions and active regions, reference is now made to FIGS. 4A through 4C. These figures illustrate an exemplary embodiment for dividing the display area into regions relative to the current pointer location.

Particularly, FIG. 4A illustrates the display area of display unit 120 as being divided into LEFT, RIGHT, UP, DOWN, and CURRENT regions relative to a current location of the pointer 400. This corresponds to an embodiment where each mouse gesture is defined in terms of movements in the left, right, up, and down directions. However, it will be readily apparent to those of ordinary skill in the art that the mouse movements for gestures (and their corresponding regions) may also be defined in terms of other directions, such as upper left, lower left, upper right, and lower right.

In FIG. 4A, a movement of the mouse 110 might cause the pointer 400 to enter one of the four regions corresponding to LEFT, RIGHT, UP, and DOWN. For instance, if the pointer 400 were to enter into the LEFT region, this would be interpreted as a LEFT mouse movement, etc. Similarly, if the pointer 400 were to enter into the DOWN region, this would be registered as a DOWN movement, and so on. If, on the other hand, if there is no significant movement of the mouse 110, and the pointer 400 remains in the CURRENT region, no further mouse movement would be registered.

However, FIG. 4B shows how the regions might be updated after a mouse movement relative to FIG. 4A. Particularly, FIG. 4B shows how the regions might be re-defined after the pointer 400 is moved into the DOWN region of FIG. 4A.

For example, it might be difficult to provide a mouse gesture whose sequence is DOWN-DOWN. Thus, assuming that such a gesture is not to be implemented, no specific DOWN region is defined in the current state of FIG. 4B. Instead, the LEFT, CURRENT, and RIGHT regions of FIG. 4B are defined in such manner as to also extend downward indefinitely (which is reasonable since such regions are used for activating respective gestures whose sequences are DOWN-LEFT, DOWN, and DOWN-RIGHT). It is also assumed in FIG. 4B that there is a valid mouse gesture associated with the sequence of movements DOWN-UP. As such, the UP region is provided for in the current state of FIG. 4B in a similar manner as in FIG. 4A.

FIG. 4C illustrates a further updating of the regions, based on a movement into the RIGHT region shown in FIG. 4B. In this example, it is assumed that none of the mouse gestures are defined as having sequence of DOWN-RIGHT-LEFT, DOWN-RIGHT-UP, DOWN-RIGHT-DOWN, or DOWN-RIGHT-RIGHT. Thus, using similar principles as described above, only the CURRENT region is defined. Further, given that the sequence of mouse movements associated with the gesture in the CURRENT region of FIG. 4C is DOWN-RIGHT, it might also make sense to extend the CURRENT region indefinitely both downward and to the right as illustrated in FIG. 4C. (FIG. 4C also illustrates regions 410 and 420 that might be defined for the sequences of DOWN-RIGHT-UP and DOWN-RIGHT-LEFT, respectively, if such mouse gestures happened to exist. As shown in FIG. 4C, hypothetical region 410 could be made to extend indefinitely upward and to the right, while hypothetical region 420 could be made to extend indefinitely downward and to the left.)

It should be recognized that FIGS. 4A through 4C are merely provided to illustrate possible ways for defining regions with respect to the current location of the pointer 400 for purposes of the present invention. These figures are not meant to be limiting on the present invention, and there may be other ways to define and update the regions in accordance with S325 of FIG. 3 as would be contemplated by persons of ordinary skill in the art.

Referring again to S325 of FIG. 3, after the display area is divided into regions, a determination is made as to whether each of these regions is an “active region.” According to one embodiment, a region is considered active if entry into such region by the pointer 400 would complete the sequence of one or more mouse movements that is associated with a particular mouse gesture. However, entry into an active region might also be part of, but not the completion of, another sequence of mouse movements that is associated with another mouse gesture.

FIG. 5 is a screen shot illustrating a particular scenario where active regions are determined in response to a mouse gesture being initiated in a web browser program, in accordance with S325 of FIG. 3. In the scenario of FIG. 5, the LEFT, RIGHT, UP, and DOWN regions are all determined to be active regions for respective mouse gestures that correspond to different browser commands. In this scenario, the specific gestures that correspond to the respective active regions would be defined as follows:

| Active | | Sequence of Movement(s) |
|---|---|---|
| Region: | Command: | Associated with Gesture: |
| UP | Stop [loading page] | UP |
| LEFT | Back [to previous page in | LEFT |
| | history] | |
| RIGHT | Forward [to next page in | RIGHT |
| | history] | |
| DOWN | Open link in new page | DOWN |
| CURRENT | - None - | - None- |

Thus, if the pointer 400 enters into any of these active regions, and the terminating event occurs thereafter (e.g., right mouse button is released inside the active region), the corresponding command is executed.

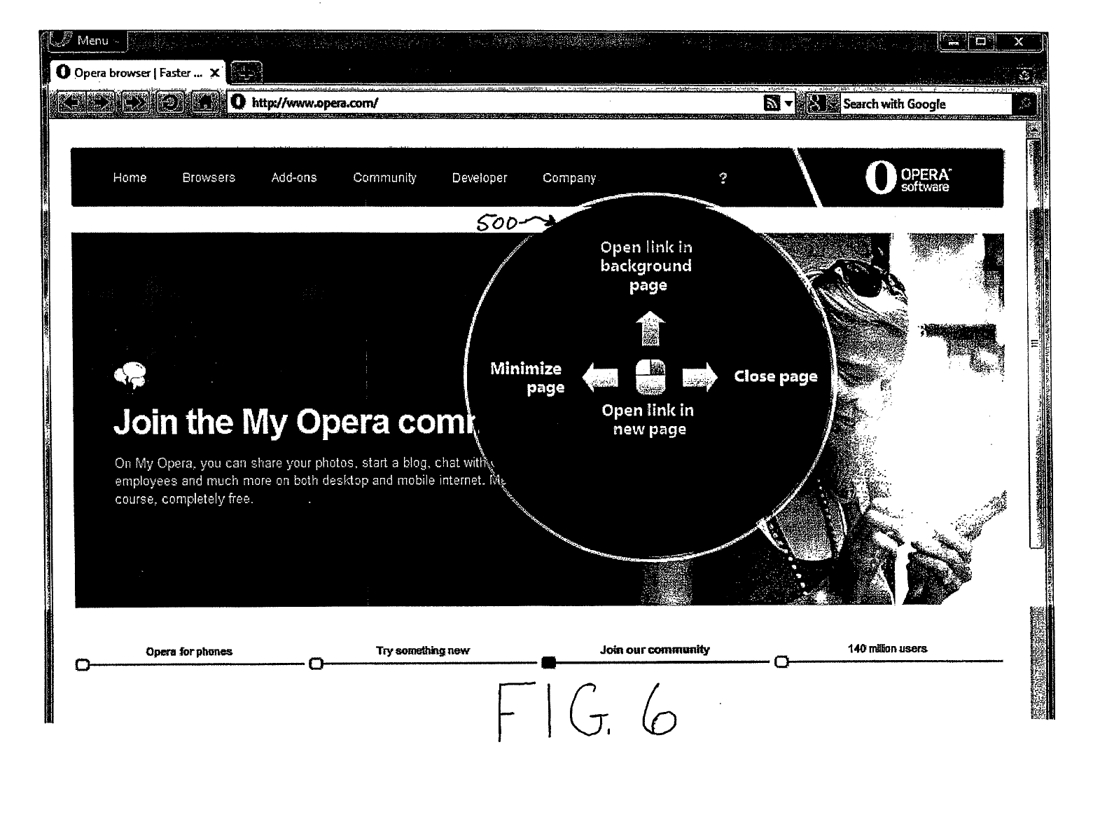

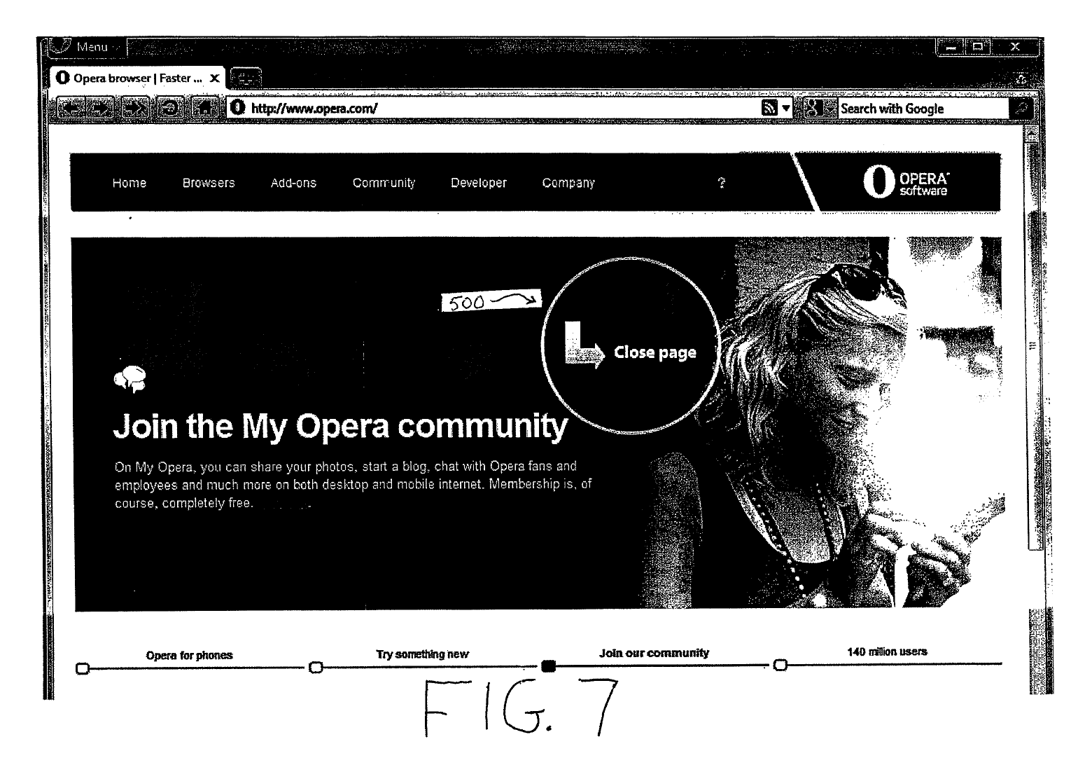

FIG. 6 is a screen shot illustrating an extension of the scenario of FIG. 5 with regard to a web browser. Particularly, in FIG. 6, the user has moved the mouse 110 so the pointer 400 enters the DOWN region, but the terminating event has not yet occurred (e.g., the user has not released the right mouse button). As such, the original commands corresponding to the UP, LEFT, and RIGHT active regions, described above in connection with FIG. 5, are no longer available. Instead, a new set of gestures are now made available to the user, and thus a new set of active regions are determined as follows:

| Active | | Sequence of Movement(s) |
|---|---|---|
| Region: | Command: | Associated with Gesture: |
| UP | Open link in background page | DOWN-UP |
| LEFT | Minimize page | DOWN-LEFT |
| RIGHT | Close page | DOWN-RIGHT |
| CURRENT | Open link in new page | DOWN |

However, in FIG. 6, the command of “Open link in new window” is still available if the user terminates the mouse gesture (e.g., releases right mouse button) while the pointer 400 remains in the CURRENT active region.

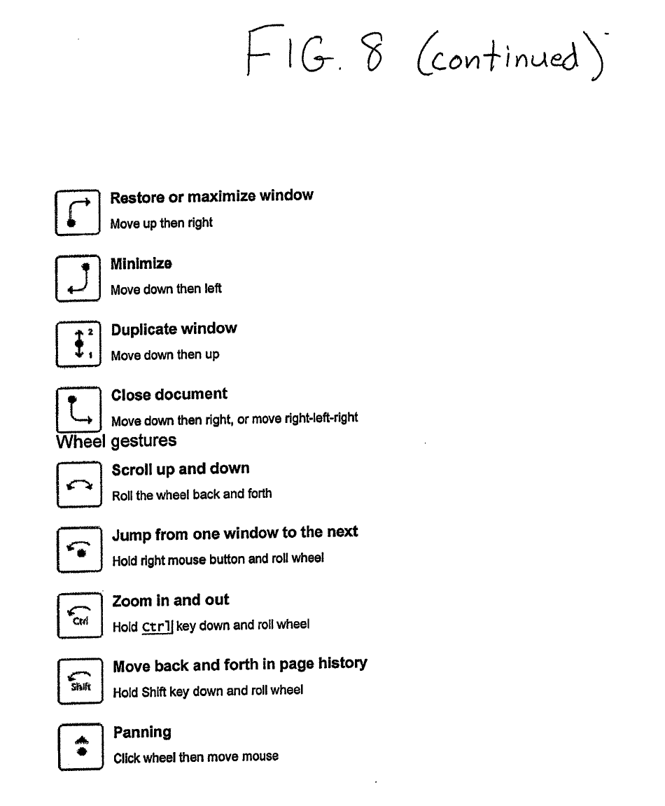

As described above in connection with FIGS. 5 and 6, consistent with exemplary embodiments of the present invention, mouse gestures can be used to carry out various command or actions for a web browser application. However, the commands described above are not the only types of web browser commands that can be carried out. FIG. 8 illustrates various examples of mouse gestures that can be implemented for a web browser or user agent in accordance with the principles of the present invention. However, the list of commands illustrated in FIG. 8 is not exhaustive of the type of commands that can be performed using mouse gestures. Furthermore, web browsers are not the only type of applications in which such mouse gestures can be used. It will be readily apparent to persons of ordinary skill that mouse gestures can be used in connection with various other types of applications in accordance with the principles of the present invention, including (but not limited to) word processing programs, video/music playing programs, windows-based operating systems, etc.

According to an exemplary embodiment, each mouse gesture may be defined in such manner that each mouse movement associated therewith enters. In this embodiment, any time the user enters a non-active region while attempting to perform a gesture would result in unsuccessful termination (and no action or command would be executed). However, this is not necessarily required. For instance, it is possible that one of the regions defined by S325 is not determined to be active, but still qualifies as part of the sequence of mouse movements that defined for a gesture. In other words, a non-active region may still be a “qualifying region” if entry therein is required, in combination with subsequent mouse movements, to perform a mouse gesture.

Referring again to FIG. 3, after the timer is started (S220), and the regions and active regions are defined relative to the location of the pointer 400 (S325), feedback will be provided to the user only if neither of the following has occurred before expiration of the timer: the mouse gesture terminates (i.e., “YES” decision in S330), or the pointer 400 is moved into an active or qualifying region (i.e., “YES” decision in S340).

According to an exemplary embodiment, if feedback is displayed to the user, as a result of expiration of the timer in accordance with S350, the feedback may be displayed in an overlay feedback interface 500 as illustrated in FIG. 5. According to this embodiment, the feedback interface 500 may display information indicating the current active regions, and the specific command or action that corresponds to each active region, as shown in FIG. 5. However, the feedback interface 500 may additionally identify, depending on the current state of the gesture, any command or action that the user can invoke at the current mouse position (e.g., by releasing the right mouse button). An example of this is the display of “Open link in new page” within the interface 500 of FIG. 6.

According to a further embodiment, such feedback interface 500 may be displayed for the duration of the mouse gesture (i.e., until a terminating event occurs), but updated when necessary. For instance, after the feedback interface 500 is initially displayed, it may need to be updated each time the user performs another mouse movement into an active region or qualifying region, in accordance with S360 and S365 of FIG. 3.

An example of such updating is provided in the scenario collectively illustrated by FIGS. 5 and 6. In this scenario, FIG. 5 illustrates the overlay feedback interface 500 being initially displayed to the user as a result of the timer expiring after the user first presses down the right mouse button. As shown in FIG. 5, the feedback interface 500 indicates there are four active regions and corresponding commands. Then, according to the scenario, the user performs a mouse movement causing the pointer 400 to enter the DOWN region. As a result of such mouse movement, the feedback interface 500 is updated as illustrated in FIG. 6. Specifically, in FIG. 6, the updated feedback interface 500 now indicates there are three active regions that are now available, and the three new commands corresponding thereto. However, the updated feedback interface 500 of FIG. 6 also indicates the command that the user can invoke by terminating the mouse gesture at the current mouse position (e.g., by releasing the right mouse button).

Also, as shown in FIGS. 5 and 6, the overlay position of the feedback interface 500 may be changed based on the current position of the pointer 400. Particularly, it is shown in FIG. 6 that, as a result of the mouse movement to the DOWN region, the position of the overlay feedback interface 500 has also been moved downward based on the current location of the pointer 400 (not shown in FIG. 6).

Referring again to FIG. 3, a terminating event for the mouse gesture may be detected before any feedback is provided (i.e., “YES” decision in S330), or after the user has been given feedback (i.e., “YES” decision in S370). In the particular exemplary embodiment illustrated in FIG. 3, subsequent processing will depend on whether or not the detected terminating event is the release of the mouse button (e.g., right mouse button) within an active region, as illustrated in S380. If the detected terminating event is the release of the mouse button in an active region (i.e., “YES” decision in S380), the command that corresponds to that active region is executed according to S290.

However, if the detected terminating event was something other than the release of the mouse button in an active region (i.e., “NO” decision in S380), this means that a mouse gesture was not successfully completed. As a result, any displayed feedback would be removed from the screen (e.g., by fading out) in S394, and the process would end at S295. In the particular embodiment of FIG. 3, any mouse movement that causes the pointer 400 to enter a non-active and non-qualifying region would be detected as an unsuccessful terminating event. Also, in this embodiment, any release of the mouse button within a non-active region would be detected as an unsuccessful terminating event, regardless of whether or not the region is a qualifying region. Other types of terminating events, which do not result in the successful completion of a mouse gesture, could also be defined. For example, the user may be allowed to press the “Esc” key (or some other key) on the keyboard to terminate the gesture before a command or action is executed.

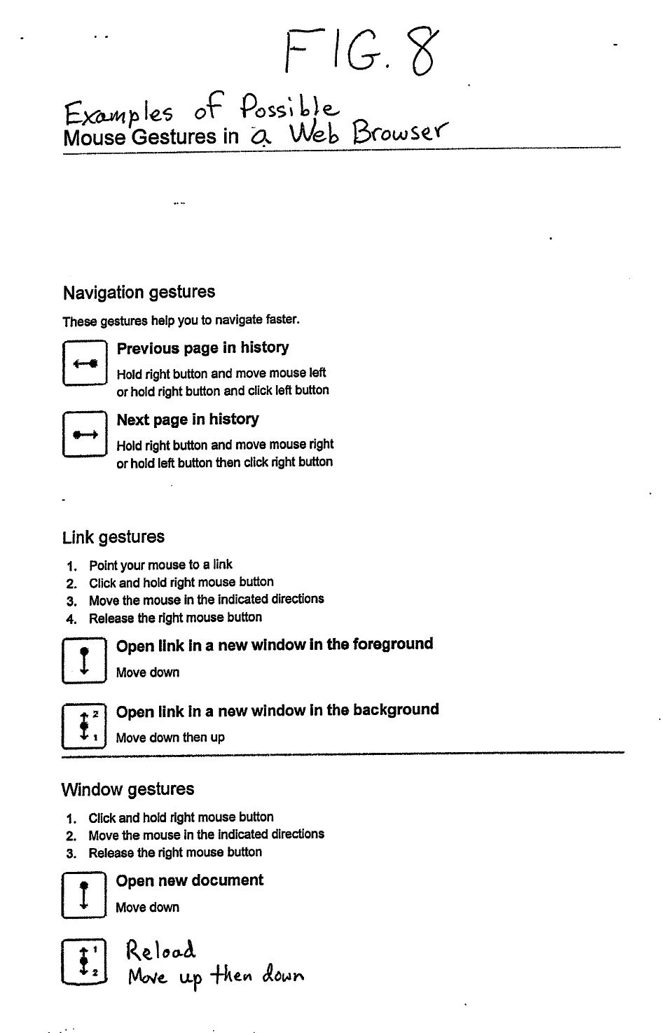

Referring again to FIG. 3, if an action or command is executed according to S290, the user may thereafter be provided with a confirmation of the corresponding mouse gesture that was just completed as shown in S392. An example of this is shown in FIG. 7, which is an extension of the scenario illustrated in FIGS. 5 and 6 with regard to a web browser application. In this extended scenario, after being presented with the feedback interface 500 of FIG. 6, the user further moves the mouse 110 to enter the RIGHT region and terminates the gesture (e.g., releases the right mouse button) therein. As a result the “Close page” command is executed. Then, as illustrated in FIG. 7, the overlay feedback interface 500 may (optionally) be shrunk, and a confirmation of the just-completed mouse gesture is displayed therein. This confirmation may indicate the action or command that was just executed, along with the sequence of one or more mouse movements for the gesture. Thus, in the example shown in FIG. 7, the overlay feedback interface 500 displays a confirmation that the “Close page” command and the DOWN-LEFT sequence correspond to the just-completed gesture.

Providing a user such confirmation may be advantageous because, when a mouse gesture is performed, it is not always immediately evident what command or action occurred as a result. As such, the user might not be sure whether he actually performed the intended mouse gesture. Furthermore, by allowing the user to visualize the entire sequence of movements upon completion of the gesture, this makes it easier for the user to learn the sequence so that feedback will no longer be necessary.

After providing the user confirmation of the just-completed gesture, the process of FIG. 3 is completed according to S295.

As mentioned, FIG. 3 is merely provided for purposes of illustration. The present invention encompasses any obvious variations thereof. For instance, release of a mouse button is but one of several types of terminating events that can be performed within an active region to invoke a corresponding command, in accordance with the present invention.

It should be noted that mouse and keyboard events (e.g., “right mouse button pressed,” “right mouse button released,” “[Esc] key pressed,” etc.), as well as mouse movements, are generally sent to the relevant application program by the operating system. The application program would then process these events and movements by means of a subroutine called an event handler, in a manner that is well known to persons of ordinary skill in the art. The event handler sends these events and movements to the subroutines that implement the processes described above, thus driving the algorithms described in FIGS. 2 and 3.

With particular embodiments being described above for purposes of example, the present invention covers any and all obvious variations as would be readily contemplated by those of ordinary skill in the art.

What is claimed is:

1. A method for providing a user feedback regarding mouse gestures for a computer application, each of the mouse gestures comprising a predetermined sequence of one or more mouse movements, each of the mouse gestures being used to invoke a corresponding application command, the method comprising:
utilizing a computer processor to execute a process comprising:
detecting an initiating event for the mouse gestures; and
outputting feedback regarding one or more potential mouse gestures that can still be performed, each time a predetermined period of time has expired after any of the following is detected: the initiating event, and a mouse movement that is associated with any of the one or more potential mouse gestures.

2. The method of claim 1, wherein, for at least one of the one or more potential mouse gestures, the outputted feedback indicates the following:
the next mouse movement which completes the associated sequence of mouse movements; and
the corresponding application command.

3. The method of claim 1, wherein the initiating event comprises an initial pressing down of a mouse button.

4. The method of claim 1, wherein the process is performed until a terminating event for the mouse gestures is detected, the terminating event comprises at least one of:
release of the pressed-down mouse button, and
detection of a mouse movement that is not associated with any of the one or more potential mouse gestures.

5. The method of claim 1, wherein the process further comprises:
detecting a location of a mouse-controlled pointer on a display of the application; and
dividing an area of the display into regions relative to the detected location, and classifying at least one of the regions as an active region,
wherein the outputted feedback identifies each active region.

6. The method of claim 5, wherein the process further comprises:
upon detecting a movement of the pointer from the detected location into an active region which is coupled with the release of a pressed-down mouse button, selecting one of the mouse gestures based on the detected movement, and invoking the application command that corresponds to the selected mouse gesture.

7. The method of claim 6, wherein the process further comprises:
outputting a confirmation of the selected mouse gesture which indicates the associated sequence of mouse movements and the invoked application command.

8. A computer system that provides a user feedback regarding mouse gestures for a computer application, each of the mouse gestures comprising a predetermined sequence of one or more mouse movements, each of the mouse gestures being used to invoke a corresponding application command comprising:
a computer processor programmed to execute a process comprising:
detecting an initiating event for the mouse gestures; and
outputting feedback regarding one or more potential mouse gestures that can still be performed, each time a predetermined period of time has expired after any of the following is detected: the initiating event, and a mouse movement that is associated with any of the one or more potential mouse gestures.

9. The computer system of claim 8, wherein, for at least one of the one or more potential mouse gestures, the outputted feedback indicates the following:
the next mouse movement which completes the associated sequence of mouse movements; and
the corresponding application command.

10. The computer system of claim 8, wherein the initiating event comprises an initial pressing down of a mouse button.

11. The computer system of claim 8, wherein the computer processor continues executing the process until a terminating event for the mouse gestures is detected, the terminating event comprises at least one of:
release of the pressed-down mouse button, and
detection of a mouse movement that is not associated with any of the one or more potential mouse gestures.

12. The computer system of claim 8, wherein the process further comprises:
detecting a location of a mouse-controlled pointer on a display of the application; and
dividing an area of the display into regions relative to the detected location, and classifying at least one of the regions as an active region,
wherein the outputted feedback identifies each active region.

13. The computer system of claim 12, wherein the process further comprises:
upon detecting a movement of the pointer from the detected location into an active region which is coupled with the release of a pressed-down mouse button, selecting one of the mouse gestures based on the detected movement, and invoking the application command that corresponds to the selected mouse gesture.

14. The computer system of claim 13, wherein the process further comprises:
outputting a confirmation of the selected mouse gesture which indicates the associated sequence of mouse movements and the invoked application command.

15. A nontransitory computer-readable medium on which is stored a program for providing a user feedback regarding mouse gestures for a computer application, each of the mouse gestures comprising a predetermined sequence of one or more mouse movements, each of the mouse gestures being used to invoke a corresponding application command, wherein the program when executed by a computer processor executes a process comprising:
detecting an initiating event for the mouse gestures; and
outputting feedback regarding one or more potential mouse gestures that can still be performed, each time a predetermined period of time has expired after any of the following is detected: the initiating event, and a mouse movement that is associated with any of the one or more potential mouse gestures.

16. The computer-readable medium of claim 15, wherein, for at least one of the one or more potential mouse gestures, the outputted feedback indicates the following:
the next mouse movement which completes the associated sequence of mouse movements; and
the corresponding application command.

17. The computer-readable medium of claim 15, wherein the initiating event comprises an initial pressing down of a mouse button.

18. The computer-readable medium of claim 15, wherein the computer processor continues executing the process until a terminating event for the mouse gestures is detected, the terminating event comprises at least one of:
release of the pressed-down mouse button, and
detection of a mouse movement that is not associated with any of the one or more potential mouse gestures.

19. The computer-readable medium of claim 15, wherein the process further comprises:
detecting a location of a mouse-controlled pointer on a display of the application; and
dividing an area of the display into regions relative to the detected location, and classifying at least one of the regions as an active region,
wherein the outputted feedback identifies each active region.

20. The computer-readable medium of claim 19, wherein the process further comprises:
upon detecting a movement of the pointer from the detected location into an active region which is coupled with the release of a pressed-down mouse button, selecting one of the mouse gestures based on the detected movement, and invoking the application command that corresponds to the selected mouse gesture.

21. The computer-readable medium of claim 20, wherein the process further comprises:
outputting a confirmation of the selected mouse gesture which indicates the associated sequence of mouse movements and the invoked application command.
